(19) United States
(12) Patent Application Publication
(10) Pub. No.: US 2008/0021764 A1
(43) Pub. Date: Jan. 24, 2008

(54) Method and system for customer value calculation

(76) Inventors: Kevin Walsh, Redwood Shores, CA (US); Pascal Sero, Foster City, CA (US); Xiruo Wang, Beijing (CN); Yong Zhou, Beijing (CN); Qiugen Hu, Beijing (CN); Long Zhang, Beijing (CN); Rong Zhang, Beijing (CN)

Correspondence Address: HICKMAN PALERMO TRUONG & BECKER/ORACLE, 2055 GATEWAY PLACE, SUITE 550, SAN JOSE, CA, 95110-1089, US

(21) Appl. No.: 11/492,510

(22) Filed: Jul. 24, 2006

(51) Int. Cl. G06Q 90/00

(52) U.S. Cl. 705/10

(57) ABSTRACT

A method and system for calculating a customer value is provided. At least one relationship type for at least one pair of customers which are selected from a plurality of customers is determined. A first customer from the plurality of customers is selected. At least one second customer having a direct relationship or an indirect relationship with the first customer based on the at least one relationship type which is selected from the relationship types is determined. The first customer value based on the first predetermined calculation rule by using first values and base values is calculated.

### FIELD OF THE INVENTION

The present invention generally relates to customer value calculation, in particular, to a method and system for calculating customer value.

### BACKGROUND

Effective marketing campaign and customer care require that key resources be concentrated on the most valuable customer. Incomprehensive and limited customer information cannot generate accurate customer value. Such customer value cannot represent the most valuable customer who needs great effort to develop relationship.

Typically, customer relationship management systems focus on the respective customer and only consider the customer's expenditure as their value. Then, these systems decide to devote the effort for maintaining customer relationship based on such customer values. So many resources are not used where they should have been used.

Based on the foregoing, it is clearly desirable to provide a method and system for calculating customer value accurately and comprehensively, which considers not only the relationship between customers, but also the potential customers.

### SUMMARY OF THE INVENTION

The present invention provides a method and system for calculating a customer value accurately and comprehensively.

According to one aspect of the present invention, there is provided a method for calculating a customer value. The method comprises the steps of: defining a first value for at least one of a plurality of first information; and using the first value and a second information to calculate the customer value based on a predetermined calculation rule, wherein, the first information is associated with a service and/or a product which is needed by the customer, the second information is associated with the consuming capacity of the customer, and the first value relates to the service and/or product.

In this method, the customer comprises both a current customer using the first information and a potential customer having the possibility to use the first information. And the consuming capacity comprises the potential consuming capacity.

Further, the predetermined calculation rule is the place of the customer's commercial value.

The predetermined calculation rule is a formula to calculate the customer value: customer value£½σF£″, second information, first value £′, wherein, the F is a function concerning the second information and the first value.

The first value is the weight of the first information.

The function F=(the second information×the first value).

According to another aspect of the present invention, there is provided a method for calculating a customer value. The method comprises the steps of: determining at least one relationship type for at least one pair of customers who are selected from a plurality of customers; selecting a first customer from the plurality of customers; determining at least one second customer having a direct relationship or an indirect relationship with the first customer based on the at least one relationship type which is selected from the relationship types; and calculating the first customer value based on the first predetermined calculation rule by using first values and base values; wherein the first values relate to at least one of relationship types, and the base values at least relate to consuming capability of the first customer or the at least one second customers.

The method further comprises the steps of: defining a second value for at least one first information; and calculating the base values of the first customer and the at least one second customer based on the second predetermined calculation rule by using the second value and first information, wherein, the second information representing service and/or product which are needed by the plurality of customers, and the first information is associated with the consuming capacities of the plurality of customers.

The method further comprises the step of selecting a calculating order for the at least one relationship type, and defining a first value for each of the at least one relationship type.

In this method, the customer comprises current customer using the second information and the potential customer having the possibility to use the second information. The customer comprises current customer using the second information and the potential customer having the possibility to use the second information. And the base values further relate to services and/or products.

The second calculation rule is a formula to calculate the customer value: customer value£½ΣF£″ first information×second value£, wherein the F is a function of the first information and the second value. The second value is the weight of the first information. And F=first information×second value.

The relationship type may be directional relationship or bi-directional relationship. And the relationship type may be hierarchy relationship. The first value is the weight of the corresponding relationship types.

When a plurality of said relationship types are in one calculating order, comparing each of the first values corresponding to said plurality of relationships with each other, and the first value being the maximum value of the first values, or the minimum value of the first values, or calculating the average value of each of the first values corresponding to said plurality of relationships, and the first value being the average value of the first values.

In the method, the directional relationship comprises at least one of the followings: parent/subsidiary, subsidiary/parent, has member/member of, member of/has member, has contactor/contactor, and so on. And the bi-directional relationship comprises at least one of the followings: spouse/spouse, partner/partner, competitor/competitor, friend/friend and so on.

When the relationship type is bi-directional relationship, the first calculation rule is a formula: V=V0+Σ(U0×aⁿ), wherein, V represents the value of a customer to be calculated currently, wherein the customer is any customer having the relationship type; during the first calculation, V0 represents the base value of the customer, and after the first calculation, V0 represents the former calculated value of the customer; U0 represents the current value of relationship customers relating to the relationship type; a represents the first value; when the customer to be calculated has direct relationship with the relationship customer, n=1; when the customer to be calculated has indirect relationship, n=the minimum number of customers passed by the relationship customer to reach the customer to be calculated currently.

The step of calculating the value of the first customer further comprising: sorting relationship customer relating to the relationship type in an ascending sequence according to the hierarchy relationship; and using the first calculation rule to calculate all of values of all the relationship customers in a sequence starting from the lowest layer of the hierarchy relationship according to the ordering.

The first calculation rule is a formula: V=V0+Σ(U0×a ), wherein, V represents the value of a customer to be calculated currently, wherein the customer is any customer having the relationship type; during the first calculation, V0 represents the base value of the customer, and after the first calculation, V0 represents the former calculated value of the customer; U0 represents the current value of relationship customers relating to the relationship type; and a represents the first value.

When the relationship type is directional relationship but not a hierarchy relationship, the first calculation rule is a formula: V=V0+Σ(U0×a ), wherein, V represents the value of a customer to be calculated currently, wherein the customer is any customer having the relationship type; during the first calculation, V0 represents the base value of the customer, and after the first calculation, the V0 represents the value of the customer calculated last time; U0 represents the current value of relationship customers relating to the relationship type; and a represents the first value.

According to another aspect of the present invention, there is provided a system. The system comprises: means for defining a first value for at least one of a first information; and means for using the first value and a second information to calculate the customer value based on a predetermined calculation rule, wherein, the first information represents service(s) and/or product(s) needed by the customer, and the second information represents the consuming capacity of the customer, and the first value relates to service(s) and/or product(s).

According to another aspect of the present invention, there is provided a system. The system comprises: means for determining one or a plurality of relationship type(s) between at least one pair of customers selected from a plurality of customers; means for selecting a first customer from the plurality of customers; means for determining at least one of second customers having direct or indirect relationship with the first customer based on at least one of relationship types selected from the relationship types; and means for calculating the first customer value based on the first predetermined calculation rule by using first values and base values, wherein the first values relate to at least one of relationship types, and the base values at least relate to consuming capability of the first customer or said at least one second customers.

According to another aspect of the present invention, there is provided a computer-readable medium. The computer-readable medium carries one or more sequences of instructions which, when executed by one or more processors, causes the one or more processors to perform the method.

According to an embodiment of the invention, it is to be understood that a customer value can be calculated comprehensively because of considering not only the relationship between customers, but also the potential customers.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow chart illustrating the steps of calculating the customer value in accordance with one embodiment of the invention;

FIG. 2 is a customer relationship net illustrating relationships among customers in accordance with one embodiment of the present invention;

FIG. 3 is a block diagram illustrating the relationships between customers and products;

FIG. 4 is a customer relationship net illustrating relationships among customers after selecting interesting relationship types according to one embodiment of the present invention;

FIG. 5 is a table illustrating the rules used by the embodiment shown in FIG. 2;

FIG. 6 is a table illustrating the whole process to calculating customer values in accordance with the embodiment shown in FIG. 2;

FIG. 7 is a block diagram of a system for calculating customer values according to the present invention; and

FIG. 8 is a block diagram of a computer system upon which embodiments of the invention are implemented.

### DETAILED DESCRIPTION

A method and system for calculating customer values is described in the following description. For the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

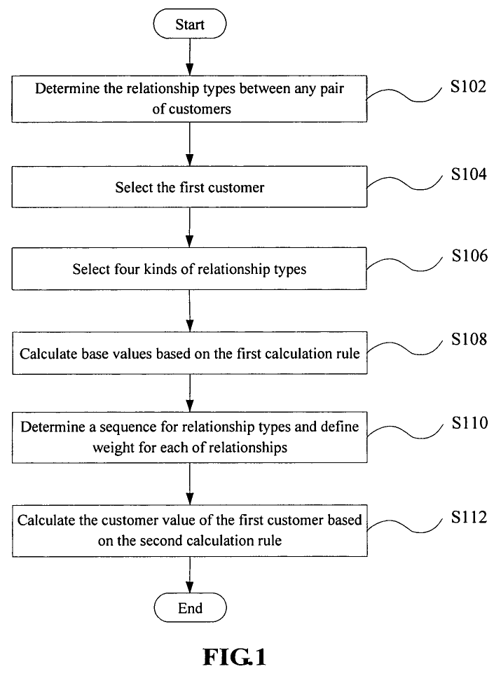

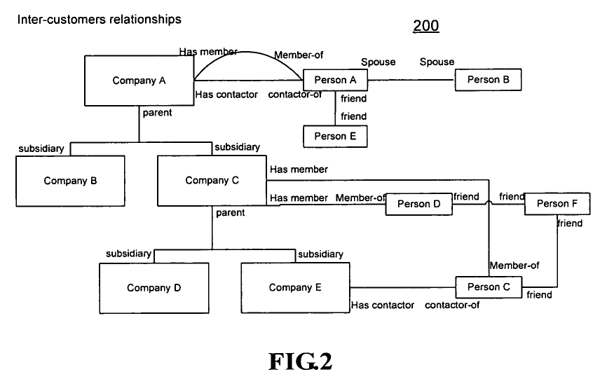

FIG. 1 is a flow chart illustrating the steps of calculating a customer value according to an embodiment of the invention. In step 102, the relationship types between any pair of customers are determined as shown in FIG. 2, a customer relationship net illustrating relationships among customers in accordance with one embodiment of the present invention. As shown in FIG. 2, the customer relationship net 200 includes eleven customers comprising five companies and six persons. And in this embodiment, there are five pairs of relationship types defined, including contactor of/have contactor, parent/subsidiary, having member/member of, friend/friend, and spouse/spouse.

“Having member” and “member of” are a pair of relationship types, representing the relationship between a company and a person, i.e., if a company has a person as its member, the company has a relationship type of “having member” and the person has a relationship type of “member of”. As shown in FIG. 2, company A has person A as its member, and company C has person C and person D as its members. On the contrary, person A, person C, and person D have a relationship type of “member of”, respectively.

Similar to relationship types “having member” and “member of”, “having contactor” and “having contactor” are also a pair of relationships, representing the relationship between a company and a person. As shown in FIG. 2, since company A has person A as its contactor, and company E has person C as its contactor, company A and company E have a relationship type of “having contactor”, respectively. On the contrary, person A and person C have a relationship type of “contactor of”, respectively.

“Parent” and “subsidiary” are a pair of relationships between two companies, i.e., if a company is a parent of another company, the company has a relationship type of “parent” and another company has a relationship type of “subsidiary”. Here, it should be noted that this pair of relationship type is a hierarchical type. As shown in FIG. 2, there are four companies having this pair of relationship type, including company A, company C, company D, and company E. In FIG. 2, company A is parent of company C, so company A has a relationship type of “parent”, and company C has a relationship type of “subsidiary”. At the same time, company C is parent of company D and company E. Therefore, company C also has a relationship type of “parent”, and company D and company E have a relationship type of “subsidiary”, respectively.

The relationship type of “friend” represents the relationship between two persons. Here, it should be noted that the relationship type of “friend” is bi-directional. That is, when two persons are friends to each other, all of these two persons have the relationship type of “friend”. As shown in FIG. 2, because person F and person E are friends, each of person F and person E has the relationship type of “friend”.

Similar to the relationship type “friend”, the relationship type of “spouse” represents the relationship between two persons and is bi-directional, too. As shown in FIG. 2, person A and person B are spouses to each other. Therefore, person A and person B have the relationship type of “spouse”.

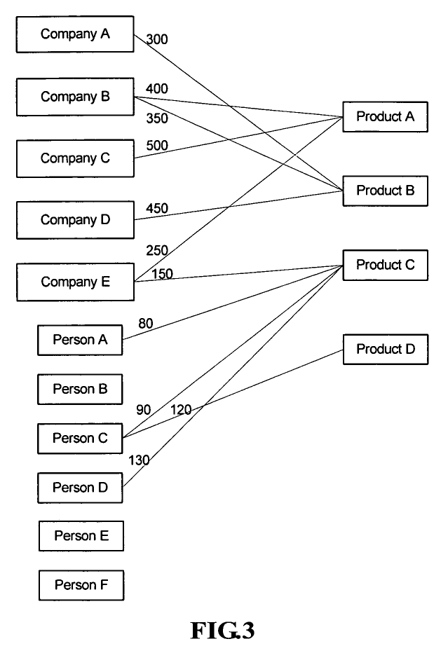

FIG. 3 is a block diagram illustrating the relationships between customers and products. In FIG. 3, the left column shows all customers shown in FIG. 2, and the right column shows all provided products. The line connecting a customer and a product represents the customer has ordered the product. The number on the line represents expenditure that the customer spent on the product. As shown in FIG. 3, the details is as follows:

Company A spent 300 on product B;

Company B spent 400 on product A and 350 on product B;

Company C spent 500 on product A;

Company D spent 450 on product B;

Company E spent 250 on product A and 150 on product C;

Person A spent 80 on product A;

Person B doesn't order any products;

Person C spent 90 on product C and 120 on product D;

Person D spent 130 on product D.

Person E doesn't order any products; and

Person F doesn't order any products.

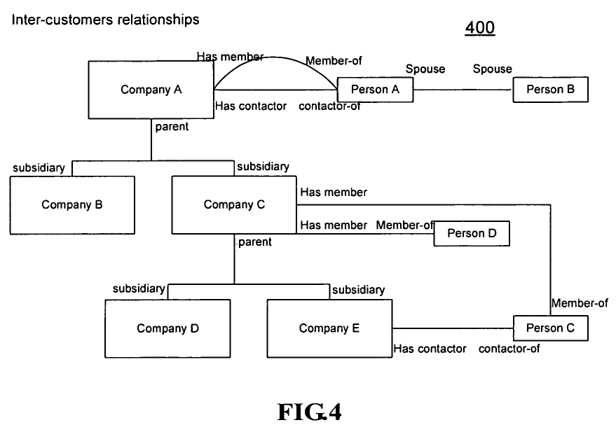

Now, one embodiment of the present invention will be described in detail with reference to FIG. 1 to FIG. 5. In step 104 of FIG. 1, the first customer is selected. In the embodiment shown in FIG. 2, for example, person B is selected. And in step 106, four kinds of relationship types are selected from the ten relationship types shown in FIG. 2, including “has member’, “parent”, “contactor of”, and “spouse”. According to these four relationship types, person E and person F are excluded because they don't have any relationship types mentioned above. So the customer relationship net 200 shown in FIG. 2 becomes the customer relationship net 400 shown in FIG. 4.

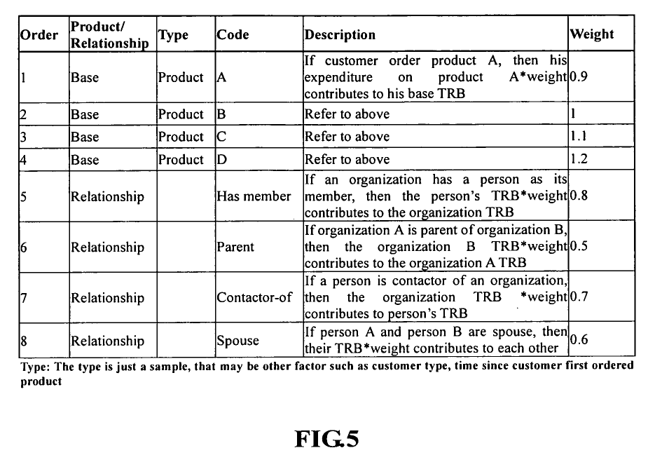

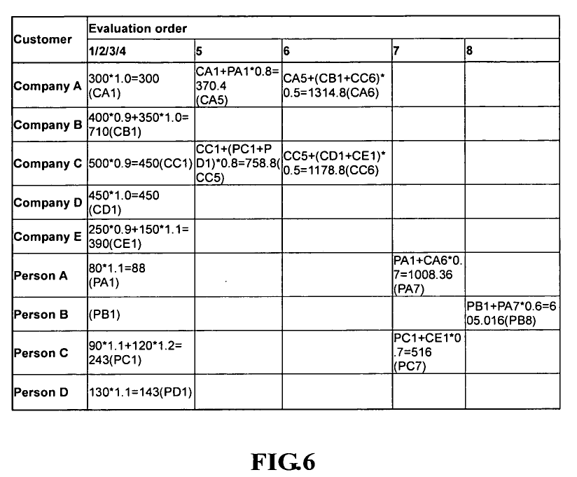

FIG. 5 is a table illustrating the rules used by the embodiment shown in FIG. 1. And FIG. 6 is a table illustrating the whole process to calculating customer values in accordance with the embodiment shown in FIG. 1. As shown in FIG. 5, selecting four relationship types from the six relationship types shown in FIG. 2.

Next in step 108, calculate base values of all the customers shown in FIG. 4 based on the first calculation rule. Here, in this embodiment, the calculation rule adopted is as orders 1 to 4 shown in FIG. 5. For example, if a customer orders product A, then his expenditure on product A*weight contributes to his base value. Here, the weight of product A is defined as 0.9. The calculation rules for product B, product C, and product D are similar to that of product A, except that the weights of product B, product C, and product D are 1, 1.1, and 1.2 respectively. As shown in FIG. 3, for example, company B spent 400 on product A and 350 on product B, respectively, therefore according to the calculation rule adopted here, the base value of product B is 400*0.9+350*1.0, equal to 710.

Similar to company B, all the base values of the customers shown in FIG. 4 can be calculated and the results are shown in column 1/2/3/4 of FIG. 6. It should be noted that various calculation rules could be adopted to calculate the base value.

Next in step 110, it determines a sequence for the selected four kinds of relationship types and defines weight for each of the relationship types. As shown in FIG. 5, order 5 is the relationship type of “has member”, and the weight defined for it is 0.8. Order 6 is the relationship type of “parent”, and the weight defined for it is 0.5. Order 7 is the relationship type of “contactor of”, and the weight defined for it is 0.7. And order 8 is the relationship type of “spouse”, and the weight defined for it is 0.6.

Then, in step 112, according to the sequence shown in FIG. 5, it calculates the value of the selected person-person B based on a predetermined calculation rule. First, from the beginning of order 5, since order 5 is “has member”, only customers who have relationship type of “has member” are considered. In the embodiment shown in FIG. 4, because company A has the relationship type of “has member” and has person A as its member, the current value of company A equals to the base value of company A+ the base value of person A*weight of the relationship type, i.e., 300+88*0.8=370.4. Similarly, because company C has person C and person D as its members, the current value of company C equals to the base value of company C+ the base value of person C*weight of the relationship type+ the base value of person D*weight of the relationship type, i.e., 450+243*0.8+143*0.8=758.8. The current values of other customers keep unchanged because they don't have a relationship type of “has member”. And the results are shown in column 5 of FIG. 6.

Next, according to order 6, the current value of each of customers having the relationship type of “parent” is calculated. It should be noted herein that the relationship type of “parent” is a kind of hierarchy relationship. Therefore, customers relating to the relationship type must be sorted ascendingly according to the hierarchy relationship. The higher layer the customer located, the later the customer calculated. In the embodiment shown in FIG. 4, company A and company C have the relationship type of “parent”. And at the same time, company A is parent of company C. Therefore, according to this rule, the current value of company C is firstly calculated, and then the current value of company A is calculated by using the current value of company C which is just calculated. And the results are shown in column 6 of FIG. 6.

Then, process proceeds to order 7. The customer value of each customer having the relationship type of “contactor-of” is determined. In the embodiment shown in FIG. 4, person A and person C have this kind of relationship type. Similar to order 5, the customer value of person A is calculated by using the current customer value of person A, and company A. And the customer value of person C is calculated by using the current customer values of person C and company E. And the results are shown in column 7 of FIG. 6.

Last, process proceeds to order 8. According to order 8, the customer value of each customer having the relationship type of “spouse” is calculated. In the embodiment shown in FIG. 4, person A and person B have the relationship type of “spouse”. Therefore, similar to order 7, the customer values of person B are calculated by using the current values of person B. And the results are shown in column 8 of FIG. 6.

Although the embodiment of the present invention has been described, the present invention is not limited to the embodiment. And those skilled in the art should appreciate that calculation rules different from the calculation rules mentioned above can be adopted. And according to the method described above, it can calculate not only the customer value of any customer in the customer relationship net, but also the customer values of all the customers in the customer relationship net at the same time.

Further, there is provided a system for calculating customer values, the system comprises means for determining one or a plurality of relationship type(s) between at least one pair of customers selected from a plurality of customers; means for selecting a first customer from the plurality of customers; means for determining at least one of second customers having direct or indirect relationship with the first customer based on at least one of relationship types selected from the relationship types; and means for calculating the first customer value based on the first predetermined calculation rule by using first values and base values, wherein, the first values relate to at least one of relationship types, and the base values at least relate to consuming capability of the first customer or at least one of second customers.

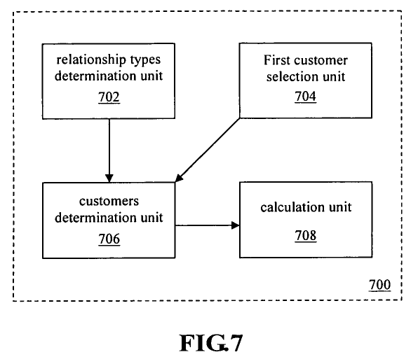

FIG. 7 is a block diagram of a system for calculating customer values according to the present invention. As shown in FIG. 7, system 700 for calculating customer values comprises: relationship types determination unit 702, means for determining one or a plurality of relationship type(s) between at least one pair of customers selected from a plurality of customers; the first customer selection unit 704, means for selecting a first customer from the plurality of customers; customers determination unit 706, means for determining at least one of second customers having direct or indirect relationship with the first customer based on at least one of relationship types selected from the relationship types; and calculation unit 708, means for calculating the first customer value based on the first predetermined calculation rule by using first values and base values. Herein, relationship type determination unit 702 determines the relationship types between the customers shown in FIG. 2. Then, the first customer selection unit 704 selects the first customer, which is person B in this embodiment. After that, customer determination unit 706 determines all the customers related to person B based on four relationship types, and in the embodiment, person A, person C, person D, company A, company B, company C, company D, and company E. Last, calculation unit 708 calculates the base values of all the customers determined by customer determination unit 706, and further calculates the customer value of person B based on these base values and a predetermined calculation rules.

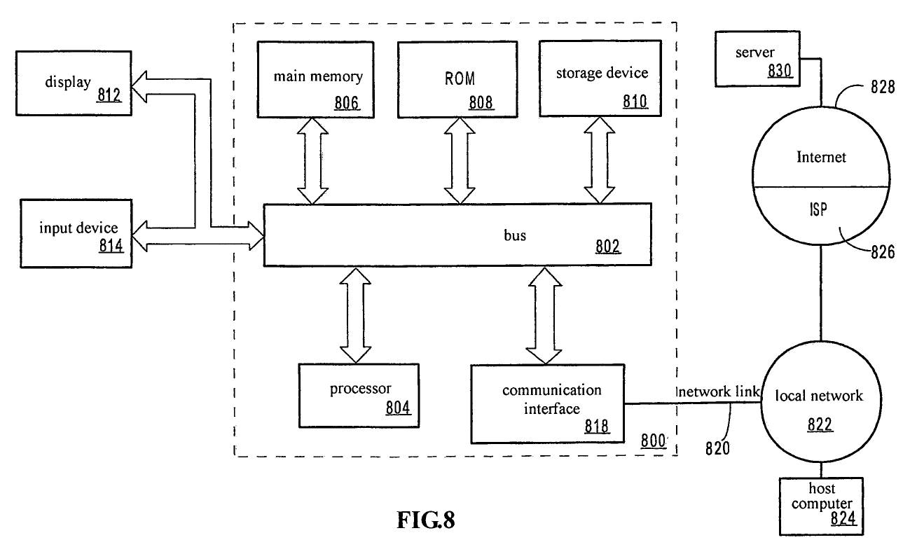

FIG. 8 is a block diagram that illustrates a computer system 800 upon which an embodiment of the invention is implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions. And in the embodiment of the present invention, information and instructions include customer information, relationship types, transaction history and setup data.

Computer system 800 may be coupled via bus 802 to a display 812, such as a cathode ray tube (CRT) or LCD, for displaying information to a computer user. An input device 814, including alphanumeric and other keys, is coupled to bus 802 for communicating information and command selections to processor 804. In the embodiment of the present invention, the customer and relationship types are input through input device 814.

The invention is related to the use of computer system 800 for implementing the techniques described herein. According to one embodiment of the invention, those techniques are performed by computer system 800 in response to processor 804 executing one or more sequences of one or more instructions contained in main memory 806. Such instructions may be read into main memory 806 from another computer-readable medium, such as storage device 810. Execution of the sequences of instructions contained in main memory 806 causes processor 804 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are exemplary forms of carrier waves transporting the information.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution. In this manner, computer system 800 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method for calculating a customer value, comprising:
defining a first value for at least one of a plurality of first information; and
using the first value and a second information to calculate the customer value based on a predetermined calculation rule;
wherein, the first information is associated with a service and/or a product which is needed by the customer, the second information is associated with the consuming capacity of the customer, and the first value relates to the service and/or product.

2. The method of claim 1, wherein, the customer comprises both a current customer using the first information and a potential customer having the possibility to use the first information.

3. The method of claim 1, wherein, the consuming capacity comprises the potential consuming capacity.

4. The method of claim 1, wherein, the predetermined calculation rule is the place of the customer's commercial value.

5. The method of claim 1, wherein the predetermined calculation rule is a formula to calculate the customer
value: customer value£½ΣF £″second information, first value£′, wherein, the F is a function concerning the second information and the first value.

6. The method of claim 1, wherein, the first value is the weight of the first information.

7. The method of claim 6, wherein, the function F=(the second information×the first value).

8. A method for calculating a customer value, comprising:
determining at least one relationship type for at least one pair of customers which are selected from a plurality of customers;
selecting a first customer from the plurality of customers;
determining at least one second customer having a direct relationship or an indirect relationship with the first customer based on the at least one relationship type which is selected from the relationship types; and
calculating the first customer value based on the first predetermined calculation rule by using first values and base values;
wherein the first values relate to at least one of relationship types, and the base values at least relate to consuming capability of the first customer or the at least one second customers.

9. The method of claim 8, further comprising:
defining a second value for at least one first information; and
calculating the base values of the first customer and the at least one second customer based on the second predetermined calculation rule by using the second value and first information,
wherein, the second information representing service and/or product which are needed by the plurality of customers, and the first information is associated with the consuming capacities of the plurality of customers.

10. The method of claim 8, further comprising selecting a calculating order for the at least one relationship type, and defining a first value for each of the at least one relationship type.

11. The method of claim 8, wherein, the customer comprises current customer using the second information and the potential customer having the possibility to use the second information.

12. The method of claim 8, wherein the base values further relates to services and/or products.

13. The method of claim 9, wherein the second calculation rule is a formula to calculate the customer value:
customer value£½ΣF £″first information×second value£′, wherein the F is a function of the first information and the second value.

14. The method of claim 13, wherein the second value is the weight of the first information.

15. The method of claim 14, wherein F=first information×second value.

16. The method of claim 8, wherein the relationship type is directional relationship or bi-directional relationship.

17. The method of claim 8, wherein the first value is the weight of the corresponding relationship types.

18. The method of claim 8, wherein further comprising: comparing each of the first values corresponding to said plurality of relationships with each other, and the first value being the maximum value of the first values.

19. The method of any one of claim 10, wherein a plurality of said relationship types are in one calculating order.

20. The method of claim 19, wherein further comprising: comparing each of the first values corresponding to said plurality of relationships with each other, and the first value being the minimum value of the first values.

21. The method of claim 19, wherein further comprising: comparing each of the first values corresponding to said plurality of relationships with each other, and the first value being the minimum value of the first values.

22. The method of claim 19, wherein further comprising: calculating the average value of each of the first values corresponding to said plurality of relationships, and the first value being the average value of the first values.

23. The method of claim 8, wherein the directional relationship comprises at least one of the followings: parent/subsidiary, subsidiary/parent, has member/member of, member of/has member, has contactor/contactor, and so on.

24. The method of claim 8, wherein the bi-directional relationship comprises at least one of the followings: spouse/spouse, partner/partner, competitor/competitor, friend/friend and so on.

25. The method of claim 16, wherein when the relationship type is bi-directional relationship, the first calculation rule is a formula:
V=V0+Σ(U0×aⁿ), wherein
V represents the value of a customer to be calculated currently, wherein the customer is any customer having the relationship type;
during the first calculation, V0 represents the base value of the customer, and after the first calculation, V0 represents the former calculated value of the customer;
U0 represents the current value of relationship customers relating to the relationship type;
a represents the first value;
when the customer to be calculated has direct relationship with the relationship customer, n=1;
when the customer to be calculated has indirect relationship, n=the minimum number of customers passed by the relationship customer to reach the customer to be calculated currently.

26. The method of claim 17, wherein the step of calculating the value of the first customer further comprises:
sorting relationship customer relating to the relationship type in an ascending sequence according to the hierarchy relationship; and
using the first calculation rule to calculate all of values of all the relationship customers in a sequence starting from the lowest layer of the hierarchy relationship according to the ordering.

27. The method of claim 26, wherein the first calculation rule is a formula:
V=V0+σ(U0×a)
wherein, V represents the value of a customer to be calculated currently, wherein the customer is any customer having the relationship type;
during the first calculation, V0 represents the base value of the customer, and after the first calculation, V0 represents the former calculated value of the customer;
U0 represents the current value of relationship customers relating to the relationship type; and
a represents the first value.

28. The method of claim 16, wherein when the relationship type is a directional relationship but not a hierarchy relationship, the first calculation rule is a formula:
V=V0+σ(U0×a)
Wherein, V represents the value of a customer to be calculated currently, wherein the customer is any customer having the relationship type;
during the first calculation, V0 represents the base value of the customer, and after the first calculation, the V0 represents the value of the customer calculated last time;
U0 represents the current value of relationship customers relating to the relationship type; and
a represents the first value.

29. A system for calculating a customer value, comprising:
means for defining a first value for at least one of a first information; and
means for using the first value and a second information to calculate the customer value based on a predetermined calculation rule,;
wherein, the first information representing service(s) and/or product(s) needed by the customer, and the second information represents the consuming capacity of the customer, and the first value relates to service(s) and/or product(s).

30. A system for calculating a customer value, comprising:
means for determining one or plurality of relationship type(s) between at least one pair of customers selected from plurality of customers;
means for selecting a first customer from the plurality of customers;
means for determining at least one of second customers having direct or indirect relationship with the first customer based on at least one of relationship types selected from the relationship types; and
means for calculating the first customer value based on the first predetermined calculation rule by using the first values and base values,
wherein the first values relate to at least one of relationship types, and the base values at least relate to consuming capability of the first customer or said at least one second customers.

31. (canceled)

32. A computer-readable medium carrying one or more sequences of instructions which, when executed by one or more processors, causes the one or more processors to perform the method recited in claim 1.

33. A computer-readable medium carrying one or more sequences of instructions which, when executed by one or more processors, causes the one or more processors to perform the method recited in claim 2.

34. A computer-readable medium carrying one or more sequences of instructions which, when executed by one or more processors, causes the one or more processors to perform the method recited in claim 3.

35. A computer-readable medium carrying one or more sequences of instructions which, when executed by one or more processors, causes the one or more processors to perform the method recited in claim 4.

36. A computer-readable medium carrying one or more sequences of instructions which, when executed by one or more processors, causes the one or more processors to perform the method recited in claim 5.

37. A computer-readable medium carrying one or more sequences of instructions which, when executed by one or more processors, causes the one or more processors to perform the method recited in claim 6.

38. A computer-readable medium carrying one or more sequences of instructions which, when executed by one or more processors, causes the one or more processors to perform the method recited in claim 7.

39. A computer-readable medium carrying one or more sequences of instructions which, when executed by one or more processors, causes the one or more processors to perform the method recited in claim 8.

40. A computer-readable medium carrying one or more sequences of instructions which, when executed by one or more processors, causes the one or more processors to perform the method recited in claim 9.

41. A computer-readable medium carrying one or more sequences of instructions which, when executed by one or more processors, causes the one or more processors to perform the method recited in claim 10.

42. A computer-readable medium carrying one or more sequences of instructions which, when executed by one or more processors, causes the one or more processors to perform the method recited in claim 11.

43. A computer-readable medium carrying one or more sequences of instructions which, when executed by one or more processors, causes the one or more processors to perform the method recited in claim 12.

44. A computer-readable medium carrying one or more sequences of instructions which, when executed by one or more processors, causes the one or more processors to perform the method recited in claim 13.

45. A computer-readable medium carrying one or more sequences of instructions which, when executed by one or more processors, causes the one or more processors to perform the method recited in claim 14.

46. A computer-readable medium carrying one or more sequences of instructions which, when executed by one or more processors, causes the one or more processors to perform the method recited in claim 15.

47. A computer-readable medium carrying one or more sequences of instructions which, when executed by one or more processors, causes the one or more processors to perform the method recited in claim 16.

48. A computer-readable medium carrying one or more sequences of instructions which, when executed by one or more processors, causes the one or more processors to perform the method recited in claim 17.

49. A computer-readable medium carrying one or more sequences of instructions which, when executed by one or more processors, causes the one or more processors to perform the method recited in claim 18.

50. A computer-readable medium carrying one or more sequences of instructions which, when executed by one or more processors, causes the one or more processors to perform the method recited in claim 19.

51. A computer-readable medium carrying one or more sequences of instructions which, when executed by one or more processors, causes the one or more processors to perform the method recited in claim 20.

52. A computer-readable medium carrying one or more sequences of instructions which, when executed by one or more processors, causes the one or more processors to perform the method recited in claim 21.

53. A computer-readable medium carrying one or more sequences of instructions which, when executed by one or more processors, causes the one or more processors to perform the method recited in claim 22.

54. A computer-readable medium carrying one or more sequences of instructions which, when executed by one or more processors, causes the one or more processors to perform the method recited in claim 23.

55. A computer-readable medium carrying one or more sequences of instructions which, when executed by one or more processors, causes the one or more processors to perform the method recited in claim 24.

56. A computer-readable medium carrying one or more sequences of instructions which, when executed by one or more processors, causes the one or more processors to perform the method recited in claim 25.

57. A computer-readable medium carrying one or more sequences of instructions which, when executed by one or more processors, causes the one or more processors to perform the method recited in claim 26.

58. A computer-readable medium carrying one or more sequences of instructions which, when executed by one or more processors, causes the one or more processors to perform the method recited in claim 27.

59. A computer-readable medium carrying one or more sequences of instructions which, when executed by one or more processors, causes the one or more processors to perform the method recited in claim 28.

60. A computer-readable medium carrying one or more sequences of instructions which, when executed by one or more processors, causes the one or more processors to perform the method recited in claim 29.

61. A computer-readable medium carrying one or more sequences of instructions which, when executed by one or more processors, causes the one or more processors to perform the method recited in claim 30.
